(19) United States
(12) Patent Application Publication
(10) Pub. No.: US 2020/0334610 A1
(43) Pub. Date: Oct. 22, 2020

(54) SYSTEMS AND METHODS FOR PROVIDING A USER INTERFACE TO AN EVENT ADMINISTRATOR FOR CONFIGURING AND INITIATING EVENTS AMONG QUICK SERVICE RESTAURANTS

(71) Applicant: HM ELECTRONICS, INC., Poway, CA (US)

(72) Inventors: James Thomas Silane, San Diego, CA (US); David Kenneth Mattox, Temecula, CA (US)

(21) Appl. No.: 16/385,474

(22) Filed: Apr. 16, 2019

(51) Int. Cl. G06Q 10/06; G06Q 50/12; G06Q 30/02

(52) U.S. Cl. CPC G06Q 10/06393; G06Q 30/0282; G06Q 50/12

(57) ABSTRACT

Systems and methods for providing a user interface to an event administrator for configuring and/or initiating events among quick service restaurants are disclosed. Exemplary implementations may: receive, through entry and/or selection by the event administrator via the user interface, event information that defines an event; initiate the event in accordance with the event information; obtain event-specific results from the individual quick service restaurants participating in the event; and generate notifications based on the obtained event-specific results, wherein the generated notifications are transferred to and presented on user interfaces of the individual quick service restaurants.

### FIELD OF THE DISCLOSURE

The present disclosure relates to systems and methods for providing a user interface to an event administrator for configuring and initiating events among quick service restaurants, and for providing an event-specific administrative user interface to enable gamification for quick service restaurants.

### BACKGROUND

Quick service restaurants are known. Measuring how long it takes to provide service to individual customers at quick service restaurants is known. Comparing performance measurements between, e.g., employees, is known.

### SUMMARY

One aspect of the present disclosure relates to a system configured for providing a user interface to an event administrator for initiating events among quick service restaurants. The system may include one or more hardware processors configured by machine-readable instructions, and/or other components. The processor(s) may be configured to receive, through entry and/or selection by the event administrator via the user interface, event information that defines an event. The event information may include event timing information, event participant information, event objective information for the event, and/or other information related to the event. The event timing information may specify an event start date, an event start time, an event stop time for the event, and/or other timing information related to the event, thereby defining an event duration between the event start time and the event stop time. The event participant information may identify individual quick service restaurants participating in the event. The event objective information may specify one or more service metrics on which the individual quick service restaurants are competing during the event. Individual ones of the service metrics may be based on service timing information that represents service durations for individual instances of service being provided during the event duration at the individual quick service restaurants participating in the event. The processor(s) may be configured to initiate the event, e.g., through the user interface. Initiation of the event may effectuate sharing of the event information with the individual quick service restaurants participating in the event. Initiation of the event may effectuate determinations, starting from the event start date, during the event duration, at the individual quick service restaurants participating in the event, of individual sets of values of the one or more service metrics. Initiation of the event may effectuate presentations on individual user interfaces associated with the individual quick service restaurants, the presentations including the individual sets of values of the one or more service metrics determined during the event duration. The processor(s) may be configured to obtain event-specific results from the individual quick service restaurants participating in the event, subsequent to completion of part or all of the event. The event-specific results may be based on the individual sets of values of the one or more service metrics that have been determined during the event duration, e.g., through aggregation, averaging, derivations, etc. The processor(s) may be configured to generate notifications based on the obtained event-specific results. The notifications may be transferred to the individual user interfaces associated with the individual quick service restaurants that have participated in the event. Subsequent to the generation of the notifications, additional or combined presentations may be presented on the individual user interfaces. These presentations may be based on the generated notifications.

Another aspect of the present disclosure relates to a method for providing a user interface to an event administrator for initiating events among quick service restaurants. The method may include receiving, through entry and/or selection by the event administrator via the user interface, event information that defines an event. The event information may include event timing information, event participant information, event objective information for the event, and/or other information related to the event. The event timing information may specify an event start date, an event start time, an event stop time for the event, and/or other timing information related to the event, thereby defining an event duration between the event start time and the event stop time. The event participant information may identify individual quick service restaurants participating in the event. The event objective information may specify one or more service metrics on which the individual quick service restaurants are competing during the event. Individual ones of the service metrics may be based on service timing information that represents service durations for individual instances of service being provided during the event duration at the individual quick service restaurants participating in the event. The method may include initiating the event, e.g., through the user interface. Initiation of the event may effectuate sharing of the event information with the individual quick service restaurants participating in the event. Initiation of the event may effectuate determinations, starting from the event start date, during the event duration, at the individual quick service restaurants participating in the event, of individual sets of values of the one or more service metrics. Initiation of the event may effectuate presentations on individual user interfaces associated with the individual quick service restaurants, the presentations including the individual sets of values of the one or more service metrics determined during the event duration. The method may include obtaining event-specific results from the individual quick service restaurants participating in the event, subsequent to completion of part or all of the event. The event-specific results may be based on the individual sets of values of the one or more service metrics that have been determined during the event duration. The method may include generating notifications based on the obtained event-specific results. The notifications may be transferred to the individual user interfaces associated with the individual quick service restaurants that have participated in the event. Subsequent to the generation of the notifications, additional or combined presentations may be presented on the individual user interfaces. These presentations may be based on the generated notifications.

As used herein, any association (or relation, or reflection, or indication, or correspondency) involving servers, processors, client computing platforms, timing information, service durations, events, times, dates, contests, participants, service metrics, values for service metrics, ranking orders, user interfaces, presentations, representations, durations, completions, indicators, indications, persons, vehicles, results, awards, notifications, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for providing a user interface to an event administrator for initiating events among quick service restaurants, in accordance with one or more implementations.

FIG. 2 illustrates a method for providing a user interface to an event administrator for initiating events among quick service restaurants, in accordance with one or more implementations.

FIG. 3 illustrates an exemplary user interface as may be provided to employees of a quick service restaurant after an event has been initiated by an event administrator as described in this disclosure, in accordance with one or more implementations.

FIG. 4 and FIG. 5 illustrate exemplary user interfaces as may be provided to employees of a quick service restaurant as described in this disclosure, in accordance with one or more implementations.

FIG. 6 illustrates an exemplary user interface as may be presented when a quick service restaurant has won an award in an event, as described in this disclosure.

FIG. 7 illustrates an exemplary user interface for an event administrator for initiating events among quick service restaurants, in accordance with one or more implementations.

FIG. 8 illustrates an exemplary user interface for an event administrator for configuring awards for quick service restaurants, in accordance with one or more implementations.

### DETAILED DESCRIPTION

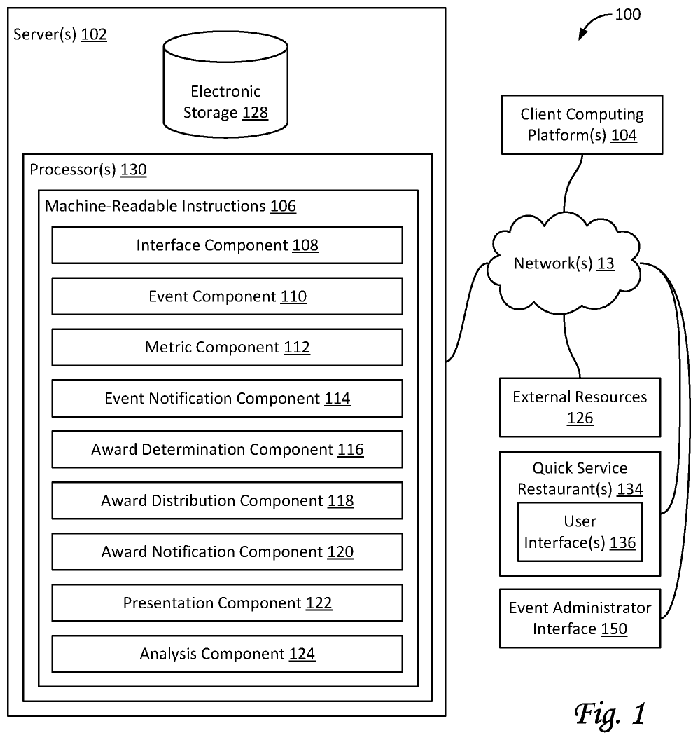

FIG. 1 illustrates a system 100 configured for providing an event administrator interface 150 (also referred to as user interface 150) to an event administrator and/or other users. The event administrator may use event administrator interface 150 to configure, initiate, launch, and/or otherwise start events among one or more quick service restaurants 134, in accordance with one or more implementations. Quick service restaurants 134 may include a first quick service restaurant, a second quick service restaurant, a third quick service restaurant, and so forth. User interfaces 136 may include a first user interface associated with the first quick service restaurant, a second user interface associated with the second quick service restaurant, a third user interface associated with the third quick service restaurant, and so forth. The first user interface may be configured to present information to the employees of the first quick service restaurant. The presented information may include information about service metrics and/or other performance indicators pertaining to the operation of the first quick service restaurant. Additionally, the presented information may include external information about external service metrics and/or other external performance indicators pertaining to the operation of other quick service restaurants. For example, the first user interface could present a ranking of the total number of customers served this week, month, or year, for multiple quick service restaurants 134. In some implementations, such a presentation may be referred to as a leaderboard.

In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104, one or more user interfaces 136, event administrator interface 150, and/or one or more other components of system 100.

Server(s) 102 may be configured by machine-readable instructions 106. Machine-readable instructions 106 may include one or more instruction components. The instruction components may include computer program components. The instruction components may include one or more of interface component 108, event component 110, metric component 112, event notification component 114, award determination component 116, award distribution component 118, award notification component 120, presentation component 122, analysis component 124, and/or other instruction components.

Interface component 108 may be configured to receive, through entry and/or selection by the event administrator via user interface 150, event information that defines one or more events. The events may include a first event, a second event, a third event, and so forth. In some implementations, the event information may include one or more of event timing information, event participant information, event objective information for the event, and/or other information related to one or more events. In some implementations, events may include one or more contests, challenges, and/or other competitions.

Event timing information may specify one or more of an event start date, an event stop date, an event start time, an event stop time for the event, and/or other information related to event timing. By way of non-limiting example, the event timing information for an individual event may specify an event start time and an event stop time for the event, thereby defining an event duration between the event start time and the event stop time. In some implementations, the event timing information may specify an event start date and an event stop date, thereby defining an event date range. For example, the first event may be associated with a first event duration, the second event may be associated with the second event duration, the third event may be associated with the third event duration, and so forth. In some implementations, the event duration may be defined as a duration between 2 and 4 hours.

In some implementations, individual events may span multiple days. For example, a particular event may last a week, a month, or another multi-day period. In some implementations, a particular event may include individual rounds of competition occurring on different days. For example, a first contest may span every Friday from 11 a.m. to 2 p.m. for 3 months. For example, a second contest may span every Monday through Thursday from 6 a.m. to 10 a.m. for 2 months. For example, a third contest may span every Saturday and Sunday from 9 a.m. to 11 a.m., between an event start date and an event stop date that are about 10 weeks apart. In these examples, the portion of the contest that falls on a single day may be referred to as a round, or a daily round.

Event participant information may identify individual quick service restaurants that are (or will be) participating in one or more events. For example, a particular event may include quick service restaurant 134 and one or more other quick service restaurants (e.g., operated by the same franchisee, located in the same geographical region, owned by the same owner, and/or otherwise having one or more characteristics in common). For a particular event, the set of quick service restaurants that are participating in the particular event may be referred to as the participating quick service restaurants or as the set of participating quick service restaurants.

Event objective information may specify one or more service metrics on which individual ones of the participating quick service restaurants are competing during a particular event. In some implementations, event objective information may specify a service metric that will be used to rank individual ones of the participating quick service restaurants during or after a particular event. In some implementations, service metrics may be based on service timing information. In some implementations, service metrics and/or service timing information may be based on service durations for individual instances of service being provided at quick service restaurant 134.

In some implementations, service timing information may be based on service durations for individual instances of service being provided at quick service restaurant 134. Service durations may be defined by the time between a (service) start time or begin time and a (service) stop time or end time. In some implementations, an individual quick service restaurant 134 may be a drive-thru restaurant. In some implementations, the start time may be defined as the moment a particular vehicle enters the drive-thru (e.g., passes a particular point on the road surface of the drive-thru). In some implementations, the start time may be defined as the moment people in the particular vehicle begin or complete their order, or pay for their order. In some implementations, the end time of a service duration may be defined as the moment particular vehicle exits the drive-thru (e.g., passes a particular point on the road surface of the drive-thru). In some implementations, the end time may be defined as the moment people in a particular vehicle receive their order, or pay for their order. Start times and end times for different customers may be interleaved, such that individual service durations partially overlap with other service durations. Service durations may include a first service duration, a second service duration, a third service duration, and so forth. Vehicles may include a first vehicle, a second vehicle, a third vehicle, and so forth. In some implementations, individual instances of service being provided at a particular quick service restaurant 134 may include a first instance of service being provided to a first person in the first vehicle, a second instance of service being provided to one or more people in the second vehicle, and so forth.

In some implementations, one or more service metrics may include one or more of average service duration per instance of service being provided at an individual quick service restaurant, percentage of the instances of service being provided for which the service duration is at or below a service duration goal, number of instances of service being provided at an individual quick service restaurant, and/or percentage reached of a goal number of instances of service being provided at an individual quick service restaurant. In some implementations, one or more service metrics may be based (at least in part) on information from the one or more points-of-sale (e.g., total sales, average sales per instance of service, etc.). Service metrics that combine service duration and information from a point-of-sale (POS) are envisioned within the scope of this disclosure. Determining the values of the one or more service metrics may be performed (e.g., by individual quick service restaurants) during the event duration, during a predetermined time period, at the completion of the event duration, and/or at the completion of the predetermined time period. For example, the average service duration per instance of service being provided at quick service restaurant 134 for the first contest (described above) may be determined by adding any service durations for instances of service provided on a Friday between 11 a.m. and 2 p.m., and dividing this total duration by the number of these instances.

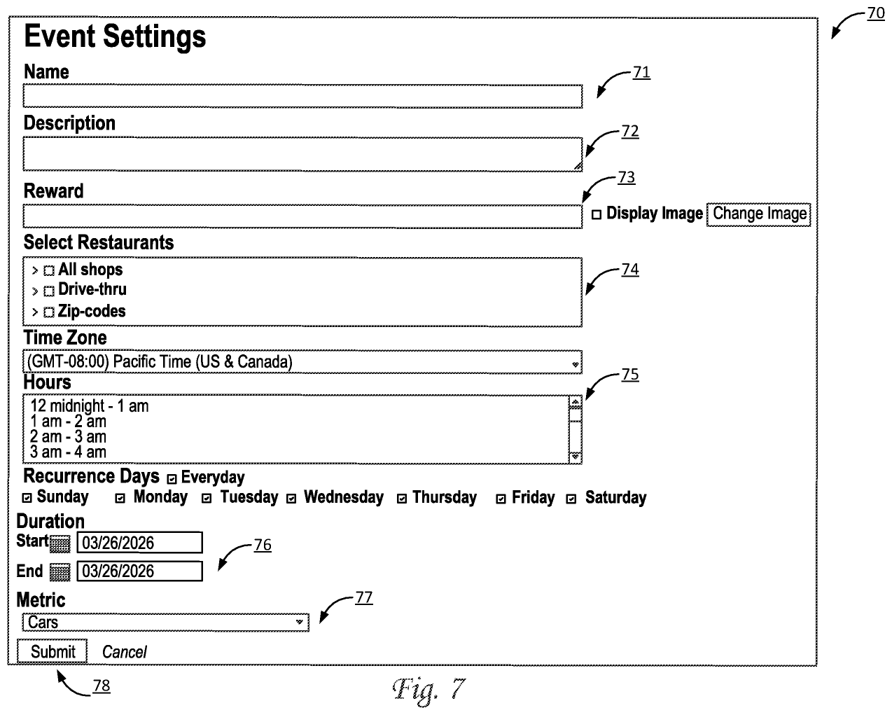

By way of non-limiting example, FIG. 7 illustrates an exemplary user interface 70 for an event administrator for initiating events among quick service restaurants. As depicted, event information may be received, through entry and/or selection by an event administrator via exemplary user interface 70. As depicted, element 71 and element 72 may be used to provide a name and description for a new event. Element 73 may be used to describe or select an award for the new event. Element 74 may be used to provide event participant information. Element 75 may be used to provide an event start time and an event stop time. Element 76 may be sued to provide an event start date and an event end date. Element 77 may be used to provide one or more service metrics to be used for ranking associated with the new event. Element 78 may be used to submit, initiate, launch, and/or otherwise start the new event as specified though user interface 70.

Referring to FIG. 1, in some implementations, the event information may include award information that identifies one or more awards that can potentially be earned by and/or awarded to the individual quick service restaurants participating in the event. Some awards may be solely based on one or more service metrics for a single quick service restaurant. Some awards may be based on comparing one or more service metrics among multiple quick service restaurants (e.g., all participating quick service restaurants). Some awards may require a combination of two or more (sequential and/or contemporaneous) accomplishments. In some implementations, an award may include an accessory for an avatar or character. In some implementations, an award may be a tag or flair that is displayed or otherwise presented in conjunction with an avatar or character. In some implementations, an award may be to animate the avatar or character with some sweet dance moves. In some implementations, an award may be negative, in the sense that the avatar of a losing quick service restaurant is changed to reflect the shame or sadness of losing (e.g., by wearing a dunce cap, or by an animation of the character making a sad face).

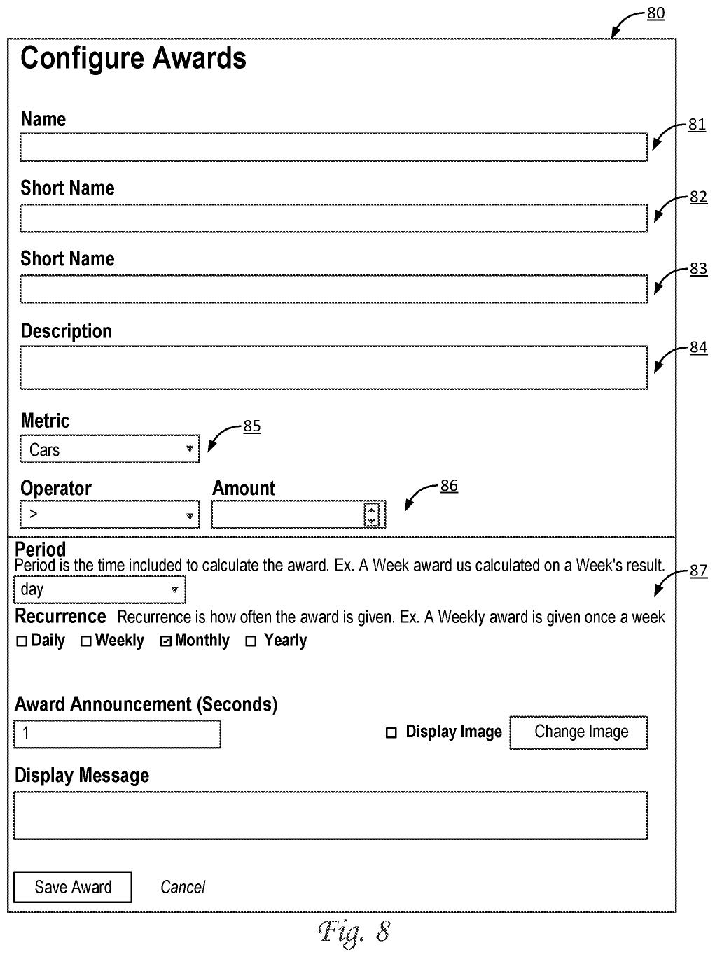

By way of non-limiting example, FIG. 8 illustrates an exemplary user interface 80 for configuring awards for quick service restaurants. In some implementations, an award may be associated with an event. In some implementations, an award may be associated with a performance indicator and/or goal. As depicted, award information may be received, through entry and/or selection by a user and/or an event administrator via exemplary user interface 80. As depicted, elements 81, 82, 83, and 84 may be used to provide different names and a description for a new award. Element 85 may be used to describe or select which service metric will be used to determine the winner of the award. Element 86 may be used to select criteria for twinning the award, such as “more than 2000 cars”. Element 87 may be used to provide period and recurrence information, such as determine whether the criteria is met per day, and make the award available for winning once per month.

Referring to FIG. 1, event component 110 may be configured to initiate, launch, and/or otherwise start events. In some implementations, the events may be configured and/or organized in accordance with the event information received by interface component 108. In some implementations, event component 110 may be configured to initiate a particular event through user interface 150 for the event administrator. In some implementations, initiation of a particular event may effectuate sharing of all or some of the corresponding event information with the individual quick service restaurants participating in the event, with the individual quick service restaurant being identified in the event participant information. In some implementations, initiation of a particular event may effectuate determinations of individual sets of values of one or more service metrics as specified in the event objective information. For example, the determinations may be performed from the event start date, during the event duration, at the individual quick service restaurants participating in the event. In some implementations, the determinations may be made by individual quick service restaurants. In some implementations, initiation of the event may effectuate presentations on individual user interfaces associated with the individual quick service restaurants. For example, the presentations may include notifications, current rankings, the individual sets of values of the one or more service metrics determined during the event duration, and/or other information.

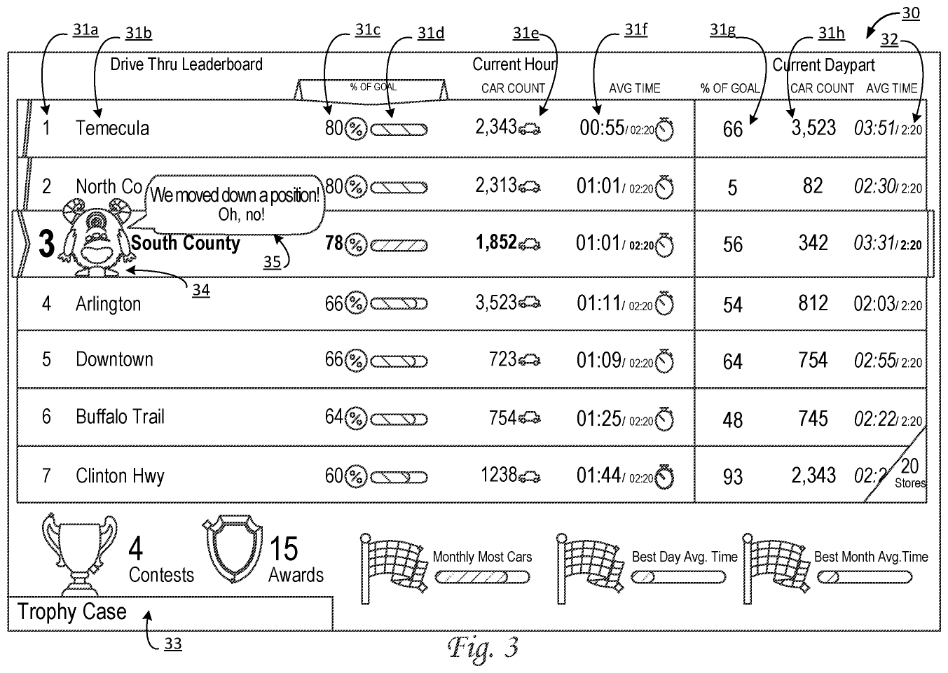

By way of non-limiting example, FIG. 3 illustrates an exemplary user interface 30 as may be presented to an individual quick service restaurant upon initiation of an event as described in this disclosure. As depicted in user interface 30, information related to an individual quick service restaurant is presented horizontally in a row. Each row includes values of service metrics and/or information derived therefrom. For example, an element 31a depicts a ranking in a ranking order. An element 31b depicts a name or identifier of an individual quick service restaurant. An element 31c depicts a service metric for the percentage of the instances of service being provided for which the service duration is at or below a service duration goal. Depending on whether the nature of the goal is a minimum or a maximum quantity, meeting a goal may be defined as reaching a metric and/or result that is below the goal, at or below the goal, at the goal, at or above the goal, or above the goal. An element 31d depicts a progress bar related to a service metric goal. An element 31e depicts the number of instances of service that have been provided at the quick service restaurant. An element 31f depicts an average service duration per instance of service being provided at the quick service restaurant (next to a service duration goal). An element 31g depicts a service metric for the percentage of the instances of service being provided for which the service duration is at or below a service duration goal. An element 31h depicts the number of instances of service that have been provided at the quick service restaurant. An element 32 depicts an average service duration per instance of service being provided at the quick service restaurant (next to a service duration goal). Elements 31c, 31d, 31e, and 31f may be associated with a particular time period or duration, such as, e.g., a current hour. Elements 31g, 31h, and 32 may be associated with a different time period or duration, such as, e.g., a current daypart. An element 33 depicts a trophy case for the “South County” quick service restaurant, which has ranking 3. For example, the quick service restaurant identified as “Temecula” is currently in first place, and “North County” is in second place, based on the values for the particular service metric being used to determine the ranking order. User interface 30 may be associated with the “South County” quick service restaurant, as is visually indicated by, e.g., the font size used for ranking element 31a in the depicted ranking order. An individual quick service restaurant may be associated with an avatar or character, here depicted as avatar 34. The information presented in each row may depict the current status of an event or contest. For example, information 35 may be depicted subsequent to a change in the ranking order (here, “South County” moved down from ranking second to ranking third). Information 35 may include context-specific feedback provided in real-time (or with minimum delay), which may be based on a change in value of one or more service metrics. Here, information 35 may be based on the relative ranking order for multiple quick service restaurants. The number of rows and columns depicted is exemplary and not intended to be limiting in any way.

Referring to FIG. 1, metric component 112 may be configured to obtain event-specific results from the individual quick service restaurants participating in one or more events. For example, metric component 112 may obtain results subsequent to completion of a particular event. In some implementations, the completion of a particular event may occur on the event stop date at the event stop time. In some implementations, the completion of a particular daily round of an event may occur at the event stop time within the event date range, on those days the daily rounds are held. The event-specific results may be based on the individual sets of values of the one or more service metrics that have been determined (e.g., by individual quick service restaurants) during the event duration. In some implementations, metric component 112 may obtain results during a particular event.

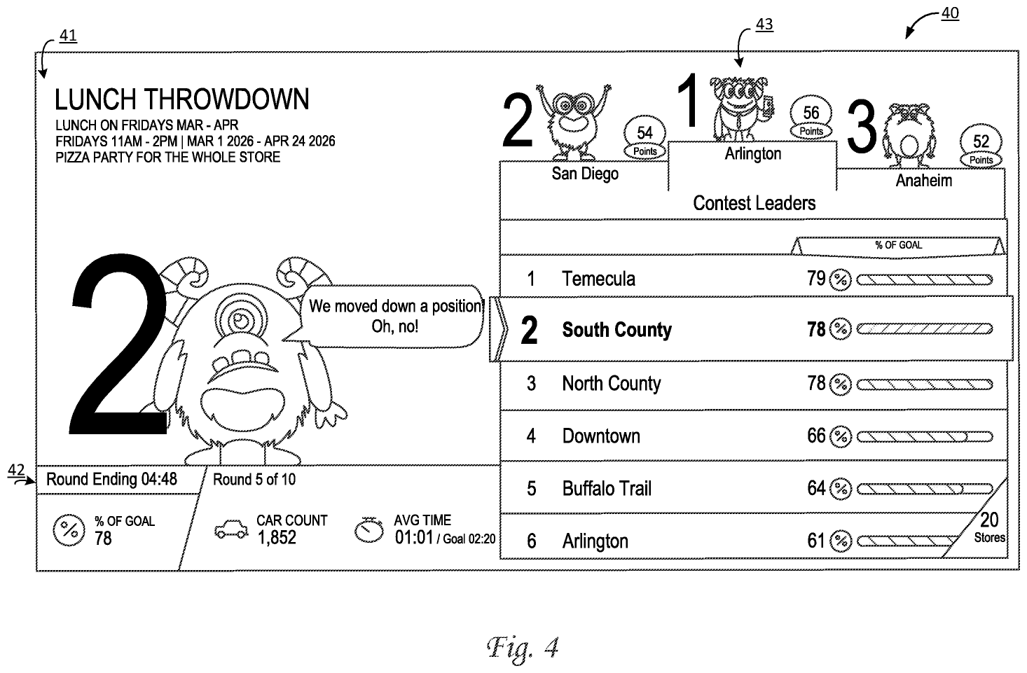

By way of non-limiting example, FIG. 4 illustrates an exemplary user interface 40 as may be provided to an individual quick service restaurant during an event. As depicted in user interface 40, information related to an individual quick service restaurant is presented horizontally in a row in the right half of user interface 40. Each row includes values of one or more service metrics and/or information derived therefrom. An informational element 41 includes event information, including the name of the event (“lunch throwdown”), event timing information, and award information (“pizza party for the whole store”). An informational element 42 depicts how much time is left in the current round (“4:48”), and that the current round is round 5 out of 10. An informational element 43 depicts the current ranking order based on the 4 completed rounds of competition, including the top three ranked quick service restaurants, their avatars, and their current scores (which may be based on points that are awarded after each round). Here, the “Arlington” quick service restaurant is ranked first in the ranking order for the entire event, with 56 points scored so far.

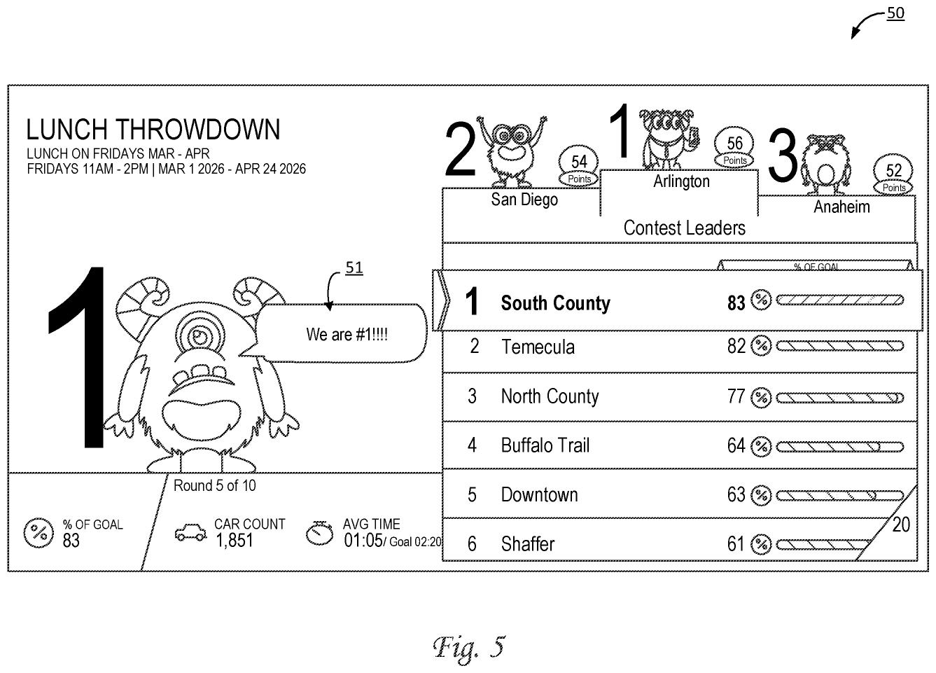

By way of non-limiting example, FIG. 5 illustrates an exemplary user interface 50 as may be provided to an individual quick service restaurant during or upon completion of an event (or a round of an event). As depicted in user interface 50, information related to an individual quick service restaurant is presented horizontally in a row in the right half of user interface 50, similar to user interface 40 in FIG. 4. As depicted in user interface 50, the current round of competition (“round 5 of 10”) may have completed, with the “South County” quick service restaurant being in first place in the ranking order. An informational element 51 provides context-specific and event-specific feedback.

Referring to FIG. 1, event notification component 114 may be configured to generate notifications based on the obtained event-specific results. In some implementations, event notification component 114 may generate notifications both during and after a round of a particular event and/or the particular event. In some implementations, the notifications may be transferred to the individual user interfaces associated with the individual quick service restaurants that are participating or have participated in the event. In some implementations, the notifications may be retrieved by the individual user interfaces associated with the individual quick service restaurants that are participating or have participated in the event. Subsequent to the generation of the notifications, presentations may be presented on the individual user interfaces associated with the individual quick service restaurants that are participating or have participated in the event. In some implementations, the presentations may be based on the generated notifications.

Referring to FIG. 1, award determination component 116 may be configured to determine which individual quick service restaurants from the quick service restaurants that are participating in the event shall be provided with one or more individual awards from the one or more identified awards. The (award) determination may be based on the obtained event-specific results. For example, assume a particular service metric is average service duration per instance of service being provided at the individual quick service restaurant. Assume, for a particular event duration, a first quick service restaurant has a service metric of 60 seconds, a second quick service restaurant has a service metric of 70 seconds, and a third service restaurant has a service metric of 80 seconds. In such a case, award determination component 116 may determine that the first quick service restaurant should be awarded the award for this particular event or round. Assume, for the same event duration, the first quick service restaurant serviced 300 vehicles, the second quick service restaurant serviced 400 vehicles, and the third service restaurant services 400 vehicles. If the particular service metric is number of instances of service provided at the individual quick service restaurant, award determination component 116 may determine that the third quick service restaurant should be awarded the award for this particular event or round. Now assume, for the same event duration, the first quick service restaurant serviced 60 percent of the vehicles within its service duration goal of 120 seconds, the second quick service restaurant serviced 70 percent of the vehicles within its service duration goal of 140 seconds, and the third service restaurant serviced 50 percent of the vehicles within its service duration goal of 160 seconds. If the particular service metric is percentage of the instances of service being provided for which the service duration is at or below a service duration goal at the individual quick service restaurant, award determination component 116 may determine that the second quick service restaurant should be awarded the award for this particular event or round. In some implementations, award determination component 116 may be configured to make determinations based on a combination of multiple service metrics, or by using particular service metrics as conditions to qualify as a potential winner. For example, a particular result may require at least 100 vehicles serviced during the event duration, but may subsequently determine the winner of an award based on the average service duration.

Award distribution component 118 may be configured to distribute awards to quick service restaurants. In some implementations, award distribution component 118 may distribute awards in accordance with one or more determinations by award determination component 116. Award distribution may include a transfer of information to the pertinent individual user interfaces associated with individual quick service restaurants.

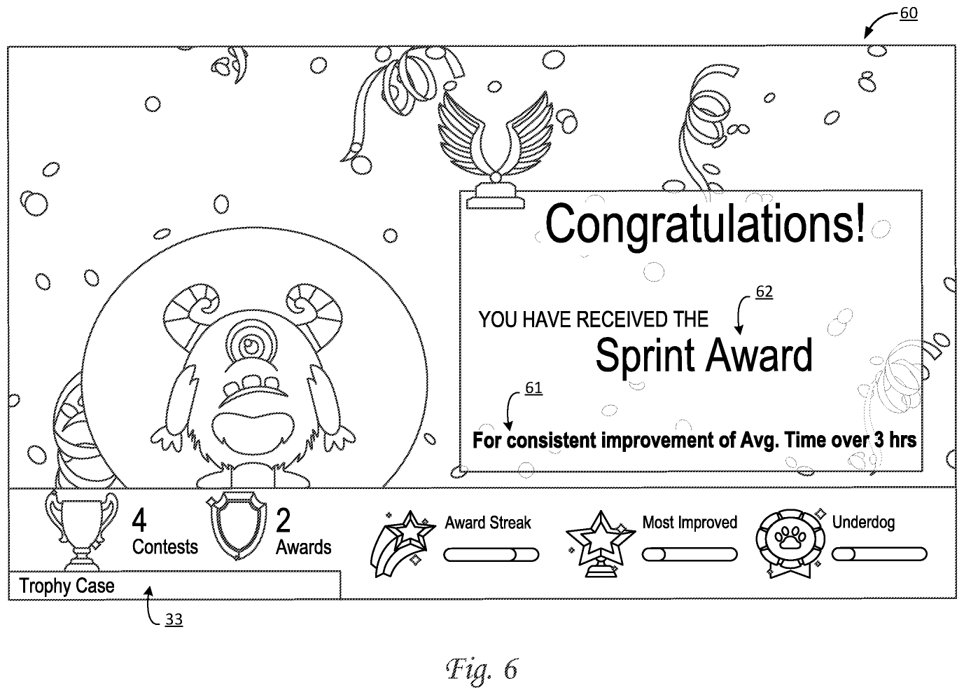

By way of non-limiting example, FIG. 6 illustrates an exemplary user interface 60 as may be provided by system 100 when a quick service restaurant has won an award in an event. As depicted in user interface 60, an informational element 62 describes the name of the award (“Sprint Award”), and an informational element 61 describes the criteria for winning the award (“consistent improvement of average time over 3 hours”). An element 33 depicts a trophy case for an individual quick service restaurant, including information regarding previously awarded awards.

Referring to FIG. 1, award notification component 120 may be configured to generate award notifications. In some implementations, award notifications may be based on determinations and/or distributions by award determination component 116, award distribution component 118, and/or other components of system 100. In some implementations, the award notifications may be transferred to one or more individual user interfaces associated with one or more individual quick service restaurants. In some implementations, presentations may be presented on the individual user interfaces, subsequent to the generation of the award notifications. For example, the presentations may be based on the generated award notifications. In some implementations, a first quick service restaurant may win a first award, but the presentations regarding the first award may be presented on multiple user interfaces, for not only the first quick service restaurant but also one or more other quick service restaurants.

Analysis component 124 may be configured to compare and/or otherwise analyze sets of values of one or more service metrics. In particular, analysis component 124 may compare values of service metrics that have been determined (e.g., by individual quick service restaurants) during the event duration. In some implementations, analysis component 124 may compare values of service metrics for at least two of the individual quick service restaurants that have participated in the same event. In some implementations, analysis component 124 may compare values of service metrics for the same individual quick service restaurant that has participated in multiple events.

Presentation component 122 may be configured to effectuate presentations on user interface 150 for the event administrator. The presentations may include notifications, information based on sets of values of service metrics, and/or other information. In some implementations, the values of the service metrics may have been determined after completion of a particular event. In some implementations, the values of the service metrics may have been determined during a particular event duration for the particular event. In some implementations, presentation component 122 may present sets of values of service metrics for at least two of the individual quick service restaurants that have participated in the same event. In some implementations, the presentations may include information determined by analysis component 124, and/or other components of system 100. In some implementations, the presentations may include information based on determination by analysis component 124, and/or other components of system 100.

In some implementations, information determined by award determination component 116, generated by award notification component 120, and/or otherwise created or obtained by system 100 may be stored in electronic storage 128. For example, analysis component 124 may compare results for a set of events spanning months or years. In some implementations, results for a single quick service restaurant may be compared among multiple contests. In some implementations, results for multiple quick service restaurants may be compared among one or more contests. For example, an award for greatest improvement of a particular service metric may be awarded to the quick service restaurant having the greatest change in the value of the particular service metric when comparing before and after a particular contest, or when comparing multiple dates (such as, e.g., a month or year apart).

In some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, 118, 120, 122, and/or 124, and/or other components. Processor(s) 130 may be configured to execute components 108, 110, 112, 114, 116, 118, 120, 122, and/or 124, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 122, and/or 124 are illustrated in FIG. 1 as being implemented within a single processing unit, in implementations in which processor(s) 130 includes multiple processing units, one or more of components 108, 110, 112, 114, 116, 118, 120, 122, and/or 124 may be implemented remotely from the other components. The description of the functionality provided by the different components 108, 110, 112, 114, 116, 118, 120, 122, and/or 124 described below is for illustrative purposes, and is not intended to be limiting, as any of components 108, 110, 112, 114, 116, 118, 120, 122, and/or 124 may provide more or less functionality than is described. For example, one or more of components 108, 110, 112, 114, 116, 118, 120, 122, and/or 124 may be eliminated, and some or all of its functionality may be provided by other ones of components 108, 110, 112, 114, 116, 118, 120, 122, and/or 124. As another example, processor(s) 130 may be configured to execute one or more additional components that may perform some or all of the functionality attributed below to one of components 108, 110, 112, 114, 116, 118, 120, 122, and/or 124.

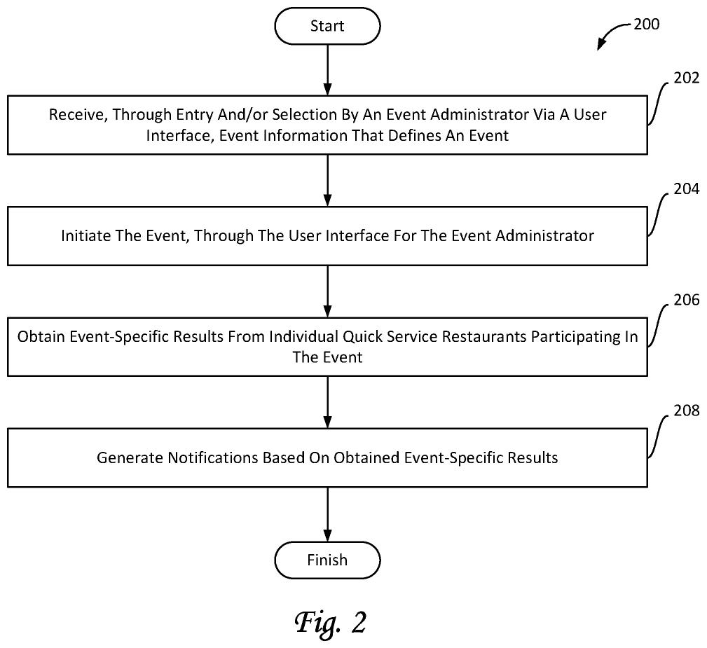

FIG. 2 illustrates a method 200 for providing a user interface to an event administrator for initiating events among quick service restaurants, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving, through entry and/or selection by the event administrator via the user interface, event information that defines an event. The event information may include event timing information, event participant information, and event objective information for the event. Operation 202 may be performed by one or more hardware processors configured by machine-readable instructions including a component that is the same as or similar to interface component 108, in accordance with one or more implementations.

An operation 204 may include initiating the event, through the user interface for the event administrator. Initiation of the event may effectuate sharing of the event information with the individual quick service restaurants participating in the event. Initiation of the event may effectuate determinations (from the event start date, during the event duration, at the individual quick service restaurants participating in the event) of individual sets of values of the one or more service metrics. Initiation of the event may effectuate presentations on individual user interfaces associated with the individual quick service restaurants of the individual sets of values of the one or more service metrics determined during the event duration. Operation 204 may be performed by one or more hardware processors configured by machine-readable instructions including a component that is the same as or similar to event component 110, in accordance with one or more implementations.

An operation 206 may include obtaining event-specific results from the individual quick service restaurants participating in the event, subsequent to completion of the event (or a round of the event). The event-specific results may be based on the individual sets of values of the one or more service metrics that have been determined during the event duration. Operation 206 may be performed by one or more hardware processors configured by machine-readable instructions including a component that is the same as or similar to metric component 112, in accordance with one or more implementations.

An operation 208 may include generating notifications based on the obtained event-specific results. The notifications may be transferred to the individual user interfaces associated with the individual quick service restaurants that have participated in the event. Subsequent to the generation of the notifications, presentations may be presented on the individual user interfaces. The presentations may be based on the notifications. Operation 208 may be performed by one or more hardware processors configured by machine-readable instructions including a component that is the same as or similar to event notification component 114, in accordance with one or more implementations.

In some implementations, a system as described in this disclosure may be used for customer-oriented businesses that are not quick service restaurants, provided there are defined moments an instance of service being provided starts and ends. Stores, pharmacies, medical offices, and/or other types of customer-oriented businesses may measure service durations and used these measurements to define service metrics and/or other metrics, which may in turn form the basis for the definition of time-limited events, a ranking order, one or more user interfaces similar to the user interfaces described above, one or more awards, and/or any other entity or object described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for providing a user interface to an event administrator for initiating events among quick service restaurants, the system comprising:
one or more hardware processors configured by machine-readable instructions to:
receive, through entry and/or selection by the event administrator via the user interface for the event administrator, event information that defines an event, wherein the event information includes event timing information, event participant information, and event objective information for the event;
wherein the event timing information specifying an event start date, an event start time and an event stop time for the event, thereby defining an event duration between the event start time and the event stop time;
wherein the event participant information identifies individual quick service restaurants participating in the event;
wherein the event objective information specifies one or more service metrics on which the individual quick service restaurants are competing during the event, wherein individual ones of the service metrics are based on timing information that represents service durations for individual instances of service being provided during the event duration at the individual quick service restaurants participating in the event;
initiate the event, through the user interface, wherein initiation of the event effectuates sharing of the event information with the individual quick service restaurants participating in the event, wherein initiation of the event effectuates determinations, from the event start date, during the event duration, at the individual quick service restaurants participating in the event, of individual sets of values of the one or more service metrics, and wherein initiation of the event effectuates presentations on individual user interfaces associated with the individual quick service restaurants of the individual sets of values of the one or more service metrics determined during the event duration;
obtain event-specific results from the individual quick service restaurants participating in the event, subsequent to completion of part or all of the event, wherein the event-specific results are based on the individual sets of values of the one or more service metrics that have been determined during the event duration; and
generate notifications based on the obtained event-specific results, wherein the notifications are transferred to the individual user interfaces associated with the individual quick service restaurants that have participated in the event, and wherein, subsequent to the generation of the notifications, presentations are presented on the individual user interfaces, wherein the presentations are based on the notifications.

2. The system of claim 1, wherein the event information includes award information that identifies one or more awards that can potentially be awarded to the individual quick service restaurants participating in the event.

3. The system of claim 2, wherein the one or more hardware processors are further configured by machine-readable instructions to:
determine one or more individual quick service restaurants from the quick service restaurants that are participating in the event, wherein the one or more individual quick service restaurants shall be provided with one or more individual awards from the one or more identified awards, wherein the determination is based on the obtained event-specific results;
distribute the one or more individual awards from the one or more identified awards in accordance with the determination, wherein distribution includes a transfer of information to the individual user interfaces associated with the individual quick service restaurants that have participated in the event.

4. The system of claim 3, wherein the one or more hardware processors are further configured by machine-readable instructions to:
generate award notifications based on the distributed one or more individual awards from the one or more identified awards, wherein the award notifications are transferred to the individual user interfaces associated with the individual quick service restaurants that have participated in the event, and wherein subsequent to the generation of the award notifications, presentations are presented on the individual user interfaces, wherein the presentations are based on the award notifications.

5. The system of claim 1, wherein the one or more hardware processors are further configured by machine-readable instructions to:
effectuate presentation, on the user interface for the event administrator, of information based on the individual sets of values of the one or more service metrics that have been determined during the event duration for at least two of the individual quick service restaurants that have participated in the event.

6. The system of claim 5, wherein the one or more hardware processors are further configured by machine-readable instructions to:
compare the individual sets of values of the one or more service metrics that have been determined during the event duration for the at least two of the individual quick service restaurants that have participated in the event;
wherein the presentation, on the user interface for the event administrator, includes information based on the comparison.

7. The system of claim 1, wherein the one or more service metrics include one or more of average service duration per instance of service being provided at the individual quick service restaurants, percentage of the instances of service being provided for which the service duration is at or below a service duration goal, and/or number of instances of service being provided at the individual quick service restaurants.

8. The system of claim 1, wherein the event timing information specifies an event stop date, and wherein the completion of the event occurs on the event stop date at the event stop time.

9. The system of claim 1, wherein the event spans multiple days and includes individual rounds of competition occurring on different days.

10. The system of claim 1, wherein the event duration is defined as a duration between 2 and 4 hours.

11. A method for providing a user interface to an event administrator for initiating events among quick service restaurants, the method comprising:
receiving, through entry and/or selection by the event administrator via the user interface for the event administrator, event information that defines an event, wherein the event information includes event timing information, event participant information, and event objective information for the event;
wherein the event timing information specifying an event start date, an event start time and an event stop time for the event, thereby defining an event duration between the event start time and the event stop time;
wherein the event participant information identifies individual quick service restaurants participating in the event;
wherein the event objective information specifies one or more service metrics on which the individual quick service restaurants are competing during the event, wherein individual ones of the service metrics are based on timing information that represents service durations for individual instances of service being provided during the event duration at the individual quick service restaurants participating in the event;
initiating the event, through the user interface, wherein initiation of the event effectuates sharing of the event information with the individual quick service restaurants participating in the event, wherein initiation of the event effectuates determinations, from the event start date, during the event duration, at the individual quick service restaurants participating in the event, of individual sets of values of the one or more service metrics, and wherein initiation of the event effectuates presentations on individual user interfaces associated with the individual quick service restaurants of the individual sets of values of the one or more service metrics determined during the event duration;
obtaining event-specific results from the individual quick service restaurants participating in the event, subsequent to completion of part or all of the event, wherein the event-specific results are based on the individual sets of values of the one or more service metrics that have been determined during the event duration; and
generating notifications based on the obtained event-specific results, wherein the notifications are transferred to the individual user interfaces associated with the individual quick service restaurants that have participated in the event, and wherein, subsequent to the generation of the notifications, presentations are presented on the individual user interfaces, wherein the presentations are based on the notifications.

12. The method of claim 11, wherein the event information includes award information that identifies one or more awards that can potentially be awarded to the individual quick service restaurants participating in the event.

13. The method of claim 12, further comprising:
determining one or more individual quick service restaurants from the quick service restaurants that are participating in the event, wherein the one or more individual quick service restaurants shall be provided with one or more individual awards from the one or more identified awards, wherein the determination is based on the obtained event-specific results;
distributing the one or more individual awards from the one or more identified awards in accordance with the determination, wherein distribution includes a transfer of information to the individual user interfaces associated with the individual quick service restaurants that have participated in the event.

14. The method of claim 13, further comprising:
generating award notifications based on the distributed one or more individual awards from the one or more identified awards, wherein the award notifications are transferred to the individual user interfaces associated with the individual quick service restaurants that have participated in the event, and wherein subsequent to the generation of the award notifications, presentations are presented on the individual user interfaces, wherein the presentations are based on the award notifications.

15. The method of claim 11, further comprising:
effectuating presentation, on the user interface for the event administrator, of information based on the individual sets of values of the one or more service metrics that have been determined during the event duration for at least two of the individual quick service restaurants that have participated in the event.

16. The method of claim 15, further comprising:
comparing the individual sets of values of the one or more service metrics that have been determined during the event duration for the at least two of the individual quick service restaurants that have participated in the event;
wherein the presentation, on the user interface for the event administrator, includes information based on the comparison.

17. The method of claim 11, wherein the one or more service metrics include one or more of average service duration per instance of service being provided at the individual quick service restaurants, percentage of the instances of service being provided for which the service duration is at or below a service duration goal, and/or number of instances of service being provided at the individual quick service restaurants.

18. The method of claim 11, wherein the event timing information specifies an event stop date, and wherein the completion of the event occurs on the event stop date at the event stop time.

19. The method of claim 11, wherein the event spans multiple days and includes individual rounds of competition occurring on different days.

20. The method of claim 11, wherein the event duration is defined as a duration between 2 and 4 hours.
